(19) United States
(12) Patent Application Publication
(10) Pub. No.: US 2026/0183663 A1
(43) Pub. Date: Jul. 2, 2026

(54) VIRTUAL OBJECT CONTROL METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventor: Tao WANG, Shenzhen (CN)

(21) Appl. No.: 19/551,744

(22) Filed: Feb. 27, 2026

Related U.S. Application Data
(63) Continuation of application No. PCT/CN2024/105301, filed on Jul. 12, 2024.

(30) Foreign Application Priority Data
Nov. 8, 2023 (CN) 202311482791.1

(51) Int. Cl. A63F 13/56; A63F 13/424; A63F 13/812; G10L 15/22; G10L 15/26

(52) U.S. Cl. CPC A63F 13/56; A63F 13/424; A63F 13/812; G10L 15/22; G10L 15/26; G10L 2015/223

(57) ABSTRACT

A virtual object control method includes: displaying the first virtual object and the second virtual object, the first virtual object being a virtual object in a main control state, and the second virtual object being a non-player controlled virtual object belonging to a same team as the first virtual object; controlling, in response to receiving a manual control instruction, the first virtual object to execute an action indicated by the manual control instruction; and controlling, in response to receiving a voice control instruction, the second virtual object to execute an action indicated by the voice control instruction.

### CROSS-REFERENCES TO RELATED APPLICATIONS

This application is a continuation of PCT Application No. PCT/CN2024/105301, filed on Jul. 12, 2024, which claims priority to Chinese Patent Application No. 202311482791.1, entitled “VIRTUAL OBJECT CONTROL METHOD AND APPARATUS, COMPUTER DEVICE, AND STORAGE MEDIUM” filed on Nov. 8, 2023, the entire contents of all of which are incorporated herein by reference.

### FIELD OF THE TECHNOLOGY

Embodiments of the present disclosure relate to the field of human-computer interaction, and in particular, to a virtual object control method and apparatus, a computer device, and a storage medium.

### BACKGROUND OF THE DISCLOSURE

In a game scenario, a player may control a virtual object through manual control operations. For example, a location of a virtual object is moved based on keyboard control, or an attribute of a virtual object is modified based on mouse control.

In a multiplayer team game (such as a basketball game or a football game), a player usually can control only one virtual object in a main control state at the same moment, and other virtual objects in a team are non-player characters (NPCs) at a current moment, which are also referred to as non-player controlled virtual objects. When the player needs to control another virtual object, a user operation is required to switch the another virtual object to the main control state.

When the foregoing control mode is used, main control state switching needs to be performed for a plurality of times, so an efficiency of controlling a plurality of virtual objects is relatively low, and cooperative actions between the plurality of virtual objects are not easily implemented.

### SUMMARY

Embodiments of the present disclosure provide a virtual object control method and apparatus, a computer device, and a storage medium. The technical solutions are as follows:

In one aspect, an embodiment of the present disclosure provides a virtual object control method, executed by a terminal, the method including: displaying the first virtual object and the second virtual object, the first virtual object being a virtual object in a main control state, and the second virtual object being a non-player controlled virtual object belonging to a same team as the first virtual object; controlling, in response to receiving a manual control instruction, the first virtual object to execute an action indicated by the manual control instruction; and controlling, in response to receiving a voice control instruction, the second virtual object to execute an action indicated by the voice control instruction.

In another aspect, an embodiment of the present disclosure provides a virtual object control apparatus, the apparatus including: a display module, configured to display the first virtual object and the second virtual object, the first virtual object being a virtual object in a main control state, and the second virtual object being a non-player controlled virtual object belonging to a same team as the first virtual object; a manual control module, configured to control, in response to receiving a manual control instruction, the first virtual object to execute an action indicated by the manual control instruction; and a voice control module, configured to control, in response to receiving a voice control instruction, the second virtual object to execute an action indicated by the voice control instruction.

In another aspect, an embodiment of the present disclosure provides a computer device, including a processor and a memory, the memory having at least one instruction stored therein, and the at least one instruction being configured for being executed by the processor to implement the virtual object control method as described in the foregoing aspect.

In another aspect, an embodiment of the present disclosure provides a non-transitory computer-readable storage medium, having at least one instruction stored therein, the instruction being loaded and executed by a processor to implement the virtual object control method as described in the foregoing aspect.

In the embodiments of the present disclosure, in response to that a player controls the first virtual object through the manual control operation, the player also controls the second virtual object through the voice control instruction, to avoid a case in which a main control switching operation switches between different virtual objects back and forth, and implement simultaneous control on the first virtual object and the second virtual object in the same team in different modes, thereby improving an efficiency of controlling the virtual objects.

### BRIEF DESCRIPTION OF THE DRAWINGS

FIG. 1 is a schematic diagram of a computer system according to an exemplary embodiment of the present disclosure.

FIG. 2 is a flowchart of a virtual object control method according to an exemplary embodiment of the present disclosure.

FIG. 3 is a schematic diagram of receiving a voice control instruction according to an exemplary embodiment of the present disclosure.

FIG. 4 is a flowchart of receiving a voice control instruction according to an exemplary embodiment of the present disclosure.

FIG. 5 is a schematic diagram of controlling the second virtual object to execute an action indicated by the voice control instruction according to an exemplary embodiment of the present disclosure.

FIG. 6 is a flowchart of extracting key information from the voice control instruction according to an exemplary embodiment of the present disclosure.

FIG. 7 is a schematic diagram of predicting an action instruction by an instruction generation model according to an exemplary embodiment of the present disclosure.

FIG. 8 is a schematic diagram of predicting an action instruction by an instruction generation model according to another exemplary embodiment of the present disclosure.

FIG. 9 is a schematic diagram of executing a confirmation operation on an object confirmation control according to an exemplary embodiment of the present disclosure.

FIG. 10 is a schematic diagram of executing a confirmation operation on a behavior confirmation control according to an exemplary embodiment of the present disclosure.

FIG. 11 is a schematic diagram of a virtual object control method according to an exemplary embodiment of the present disclosure.

FIG. 12 is a structural block diagram of a virtual object control apparatus according to an exemplary embodiment of the present disclosure.

FIG. 13 is a schematic structural diagram of a computer device according to an exemplary embodiment of the present disclosure.

### DESCRIPTION OF EMBODIMENTS

In the present disclosure, in a process of collecting related data (such as manual control operations, manual control instructions and voice control instructions) of a user, a prompt interface or a pop-up window may be displayed, or voice prompt information may be outputted. The prompt interface, the pop-up window, or the voice prompt information is configured for prompting, for the user, that related data of the user is currently being collected, so that in the present disclosure, only after a confirmation operation performed by the user on the prompt interface or the pop-up window is obtained, a related operation of obtaining the related data of the user is started, and otherwise (that is, when the confirmation operation performed by the user on the prompt interface or the pop-up window is not obtained), the related operation of obtaining the related data of the user is terminated, that is, skipping obtaining the related data of the user. In other words, information (including but not limited to user device information, user personal information, and voice control instructions of the user), data (including but not limited to analyzed data, stored data, displayed data, and the like), and signals involved in the present disclosure are all authorized by the user or fully authorized by all parties, and collection, use and processing of related data need to comply with relevant laws, regulations, and standards in relevant countries and regions. For example, the voice control instructions of the user and the like involved in the present disclosure are all obtained under full authorization.

In most games, virtual objects are usually controlled by manual control operations. For example, the virtual objects are controlled by using a keyboard, a mouse, or buttons.

In a multiplayer team game (such as a basketball game or a football game), a player usually can control only one virtual object in a main control state at the same moment, and other virtual objects in a team are non-player characters (NPCs) at a current moment. When the player needs to control another virtual object, the player needs to switch the another virtual object to the main control state.

In a team game, cooperation between virtual objects in the same team is very important. However, when the foregoing mode is used, main control state switching needs to be performed for a plurality of times, so an efficiency of controlling a plurality of virtual objects is relatively low, and cooperative actions between the plurality of virtual objects are not easily implemented.

Therefore, the present disclosure provides a virtual object control method, which can control the second virtual object based on a voice control instruction while controlling the first virtual object by using a manual control instruction, so as to efficiently controlling the plurality of virtual objects at the same time, thereby improving a control efficiency and increasing a cooperation between the plurality of virtual objects.

The present disclosure is described by taking a basketball team game as an example, but does not constitute a limitation to an application scenario applicable to the present disclosure. The method provided in the present disclosure may be applied to an application program having the plurality of virtual objects. By way of example only, the method provided in the present disclosure may be applied to a virtual team ball game (for example, a team game such as football, volleyball, or hockey). Exemplarily, the method provided in the present disclosure may also be applied to any program among a virtual reality (VR) program, an augmented reality (AR) program, a three-dimensional map program, a VR game, an AR game, the first-person shooting (FPS) game, the third-person shooting (TPS) game, multiplayer online battle arena (MOBA) games, and a simulation game (SLG).

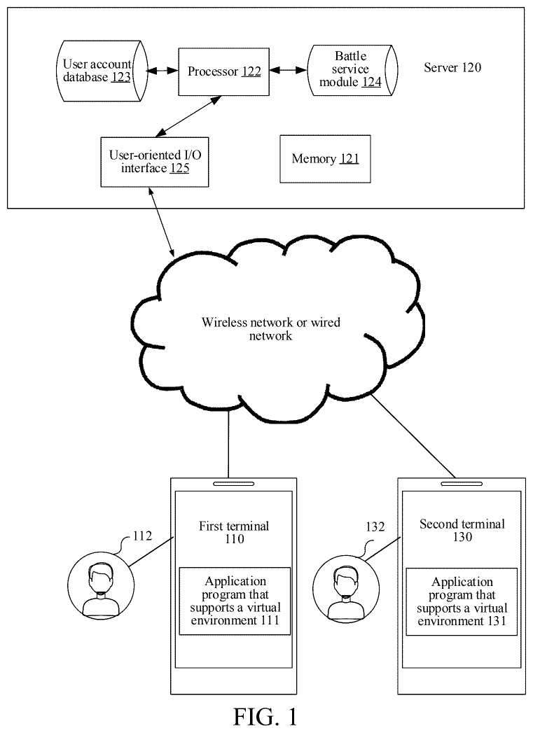

Referring to FIG. 1, FIG. 1 is a schematic diagram of a computer device according to an exemplary embodiment of the present disclosure.

The computer system may include: the first terminal 110, a server 120, and the second terminal 130.

An application program 111 that supports a virtual environment is run in the first terminal 110, where the application program 111 may be a virtual team ball battle game. When the first terminal 110 runs the application program 111, a user interface of the application program 111 is displayed on a screen of the first terminal 110. In the present disclosure, an example in which the application program 111 is a basketball team game is used for description. The first terminal 110 is a terminal used by the first user 112. The first user 112 uses the first terminal 110 to control the first virtual object in a virtual team ball battle picture to perform activities by manual control operations. The first virtual object may be referred to as a main control virtual object of the first user 112. The activities of the first virtual object include, but not limited to, at least one of body posture adjustment, walking, running, jumping, layup, offense and defense, and pick and roll. Meanwhile, the first user 112 also controls, by using the first terminal 110, second virtual objects in the virtual team ball battle picture to perform activities by voice control instructions. In some embodiments, the second virtual objects are other virtual objects belonging to the same team as the first virtual object, and the second virtual objects and the first virtual object are teammates of each other. In an example, the second virtual objects may be NPCs, which are also referred to as non-player controlled virtual objects. The second virtual objects are not controlled by the manual control operations of the first user 112, but may be controlled by voice of the first user 112 in this embodiment. Exemplarily, the first virtual object and the second virtual objects are virtual characters, such as simulated characters or anime characters.

An application program 131 that supports the virtual environment is run in the second terminal 130, and the application program 131 may be a virtual team ball battle game. When the second terminal 130 runs the application program 131, a user interface of the application program 131 is displayed on a screen of the second terminal 130. In the present disclosure, an example in which the application program 131 is a basketball team game is used for description. The second terminal 130 is a terminal used by the second user 132. The second user 132 uses the second terminal 130 to control the first virtual object in a virtual team ball battle picture to perform activities by manual control operations, and at the same time, the second user 132 also controls the second virtual objects in the virtual team ball battle picture to perform activities by voice control instructions.

In some embodiments, based on the fact that the first virtual object controlled by the first user 112 and the first virtual object controlled by the second user 132 belong to the same or different teams, the following cases exist: In some embodiments, the first virtual object controlled by the first user 112 and the first virtual object controlled by the second user 132 may be different virtual objects in the same team in the same virtual team ball battle game. The first virtual object controlled by the second user 132 and the first virtual object controlled by the first user 112 are teammates of each other. In some embodiments, the first virtual object controlled by the first user 112 and the first virtual object controlled by the second user 132 may be different virtual objects in different teams in the same virtual team ball battle game.

In some embodiments, the virtual objects in the same team may include NPCs, which are also referred to as non-player controlled virtual objects or artificial intelligence (AI) virtual objects. For example, the second virtual objects may be NPCs. In some embodiments, a program for controlling NPCs may be pre-stored in the first terminal 110 and the second terminal 130 by using the application program 111 and the application program 131. In some embodiments, in response to that the second virtual objects are NPCs, taking the first terminal 110 as an example, when the first terminal 110 does not receive the voice control instruction, the second virtual objects are still controlled according to an original program for controlling NPCs. When the first terminal 110 receives the voice control instruction, the second virtual objects execute control based on the voice control instruction. When the second virtual objects are controlled to execute an action indicated by the voice control instruction and the next voice control instruction is not received, the second virtual objects are still controlled according to the original program for controlling NPCs.

In some embodiments, the application programs installed on the first terminal 110 and the second terminal 130 are the same, or the application programs installed on the first terminal 110 and the second terminal 130 are the same type of application programs on different operating system platforms (Android or IOS). The first terminal 110 may generally refer to one of a plurality of terminals, and the second terminal 130 may generally refer to another one of the plurality of terminals. This embodiment only takes the first terminal 110 and the second terminal 130 as examples for description. The first terminal 110 and the second terminal 130 are of the same or different types of devices, including: at least one of a smartphone, a tablet computer, an e-book reader, a moving picture experts group audio layer III (MP3) player, a moving picture experts group audio layer IV (MP4) player, a laptop portable computer, and a desktop computer.

FIG. 1 shows only two terminals. However, there are a plurality of other terminals that can access the server 120 in different embodiments. In some embodiments, one or more terminals are terminals corresponding to a developer. By installing a developing and editing platform for an application program that supports a virtual environment in the terminal, the developer can edit and update the application program on the terminal, and transmit an updated application program installation package to the server 120 through a wired or wireless network. The first terminal 110 and the second terminal 130 may download the application program installation package from the server 120 to update the application program.

In some embodiments, models such as an instruction generation model, the first object determining model, the second object determining model, or a target behavior prediction model mentioned in the present disclosure may be deployed in the terminals (for example, the first terminal 110 and the second terminal 130), or may be deployed in the server 120.

The first terminal 110, the second terminal 130, and another terminal are connected to the server 120 through a wired network or wireless network.

The server 120 includes at least one of one server, a server cluster including a plurality of servers, a cloud computing platform, and a virtualization center. The server 120 is configured to provide a backend service for an application program that supports a three-dimensional virtual environment. In some embodiments, the server 120 is in charge of primary computing works, and the terminal is in charge of secondary computing works; alternatively, the server 120 is in charge of the secondary computing works, and the terminal is in charge of the primary computing works; and alternatively, the server 120 and the terminal perform collaborative computing by using a distributed computing architecture.

In an exemplary example, the server 120 includes a memory 121, a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the another terminal, such as avatars of the user accounts, nicknames of the user accounts, fighting power indexes of the user accounts, and service areas of the user accounts. The battle service module 124 is configured to provide a plurality of battle rooms for users to battle, for example, a 3V3 battle room and a 5V5 battle room. The user-oriented I/O interface 125 is configured to establish communication and exchange data with the first terminal 110 and/or the second terminal 130 via a wireless network or a wired network.

In the virtual object control method provided in this embodiment of the present disclosure, the operations may be executed by a terminal. The terminal may be specifically the first terminal 110 and/or the second terminal 130 shown in FIG. 1. For example, an application program installed and run in the first terminal 110 executes the virtual object control method, or the first terminal 110 and/or the second terminal 130 and the server 120 interact and cooperate with each other to execute the virtual object control method. Taking the first terminal 110 and the server 120 as an example, the first terminal 110 transmits a received manual control instruction and/or voice control instruction to the server 120, and the server 120 analyzes and determines an action indicated by the manual control instruction and/or voice control instruction. The server 120 transmits information related to the action to the first terminal 110, and the first terminal 110 controls the first virtual object and/or the second virtual objects to execute a corresponding action.

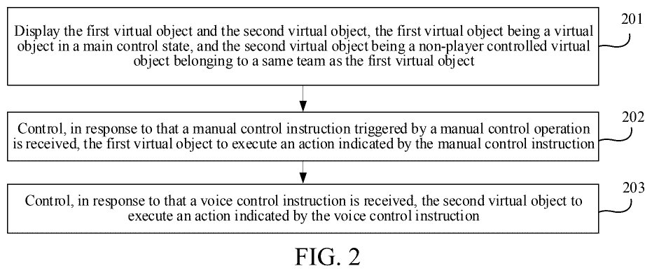

Referring to FIG. 2, FIG. 2 is a flowchart of a virtual object control method according to an exemplary embodiment of the present disclosure. The method may be executed by a terminal. The terminal may be specifically the first terminal 110 and/or the second terminal 130 shown in FIG. 1. The method includes at least some of operation 201, operation 202, and operation 203.

Operation 201: Display the first virtual object and the second virtual object, the first virtual object being a virtual object in a main control state, and the second virtual object being a non-player controlled virtual object belonging to a same team as the first virtual object.

Exemplarily, a virtual battle picture is displayed. The virtual battle picture includes the first virtual object and second virtual object. The virtual battle picture is a picture of a current battle in a multiplayer team game. In some embodiments, in an example in which the multiplayer team game is a virtual team ball game, the virtual battle picture is a virtual team ball battle picture.

Exemplarily, in a scenario in which the virtual team ball game is a basketball team game, the virtual battle picture may be a picture of a basketball game battle between two teams. In some embodiments, the virtual battle picture includes all or some of virtual objects (for example, active players, coaches, and substitute players) of the two teams.

In some embodiments, the virtual battle picture may further include a picture related to a court. For example, in a scenario in which the virtual team ball game is a basketball team game, the virtual battle picture further includes a picture related to a basketball court. For example, the virtual battle picture includes a basketball, baskets, backboards, side lines, three-point lines, a free throw lines, a center line, a center circle, and the like.

The virtual objects in the virtual battle picture may be in a form of virtual characters, anime characters, virtual roles, or the like, and the virtual objects may be displayed by using a two-dimensional model or a three-dimensional model. In some embodiments, in a scenario of a basketball team game, the virtual objects may alternatively be virtual basketball stars.

The first virtual object is a virtual object in a main control state, which is also referred to as a main control virtual object, that is, a virtual object mainly controlled by a player. In some embodiments, the player controls the first virtual object through manual control operations. The second virtual objects belonging to the same team as the first virtual object include NPCs, which are also referred to as non-player controlled virtual objects or AI virtual objects, and are not controlled by the manual control operations of the player. In this embodiment, the second virtual objects are controlled by a voice of the player.

In some embodiments, the player may switch the virtual object in the main control state to another virtual object in the same team through a main control switching operation. For example, the virtual object in the main control state at the current moment is “Player No. 5”. In response to that the player executes the main control switching operation, the virtual object in the main control state is switched to “Player No. 8”, and “Player No. 8” is controlled through the manual control operations; and “Player No. 5” turns into an NPC, and is not controlled by the manual control operations of the player. The main control switching operation is an operation of switching the virtual object in the main control state at the current moment. In some embodiments, the main control switching operation may be a click/tap and swap operation on two virtual objects, or may be an operation executed in a mode such as a preset gesture or a shortcut key. This is not limited in this embodiment of the present disclosure.

Operation 202: Control, in response to receiving a manual control instruction, the first virtual object to execute an action indicated by the manual control instruction.

In some embodiments, the manual control operation includes a control operation executed in a form of a mouse, a keyboard, or a button. For example, the manual control operation includes an operation such as triggering the keyboard or a mouse to move a location of the first virtual object or change an attribute or an action of the first virtual object; or an operation such as clicking/tapping, double-clicking/tapping, or long-pressing a button in the virtual battle picture to indicate a traveling direction or a battle strategy of the first virtual object.

The manual control instruction is an instruction obtained by the terminal by receiving the manual control operation. The manual control instruction is configured for instructing the first virtual object to execute an instructed action. For example, in a scenario in which the virtual team ball game is a basketball team game, an action indicated by one manual control instruction may be a layup action, a movement to Player No. 1 in the opposite team, a pick and roll or steal action to Player No. 2 in the opposite team, or the like.

Operation 203: Control, in response to receiving a voice control instruction, the second virtual object to execute an action indicated by the voice control instruction.

The voice control instruction is a control instruction inputted by the player through a voice input operation. The voice input operation is executed by the player based on a voice input component in the terminal. The voice input component may be a microphone in the terminal, or a voice input device external to the terminal, such as an earphone. For example, the terminal includes a microphone. In response to that a microphone permission authorized by the player is obtained, the terminal may receive the voice control instruction inputted by the player through the microphone.

In some embodiments, the second virtual objects are other virtual objects belonging to the same team as the first virtual object. For example, the second virtual objects may be other active players or substitute players in the team. In some embodiments, the second virtual objects are NPCs, and are not controlled by the manual operations of the player.

In some embodiments, when receiving the voice control instruction, the terminal analyzes a content of the voice control instruction to determine the action indicated by the voice control instruction, and controls the second virtual object to execute the action indicated by the voice control instruction. In some embodiments, the content of the voice control instruction is analyzed by using a pre-trained natural language processing model or a large language model. The natural language processing model may be a neural network model based on a Transformer architecture. Exemplarily, a content corresponding to one voice control instruction may be “The center runs a pick and roll to Player No. 10 in the opposite team”, “Substitute Player No. 4 substitutes Player No. 5 on the court”, or the like.

In one embodiment, the terminal may further display a text prompt box in the virtual battle picture, and display a voice text corresponding to the voice control instruction in the text prompt box, to prompt the player of the content of an inputted voice control instruction. The text prompt box may be fixedly displayed at a lowermost position or an uppermost position of the virtual battle picture, or may be displayed in a mobile mode in the virtual battle picture. For example, the voice text in the text prompt box may be “Player No. 2 gives help defense to Player No. 1”.

In some embodiments, the terminal may receive the voice control instruction under a certain trigger condition. In some embodiments, a voice command control is further displayed on the virtual battle picture. The trigger condition may be that a trigger operation on the voice command control is received, or a trigger operation on the voice command control is received within a certain duration, or an operation triggered through a preset gesture is received, or an operation triggered through a shortcut key is received. For example, the voice control instruction is only received when a trigger operation on the voice command control or an operation indicated by a preset gesture or a shortcut key is received.

The manual control instruction and the voice control instruction may be received sequentially or simultaneously. That is, operation 202 and operation 203 may be executed sequentially or simultaneously. This is not limited in this embodiment of the present disclosure. For example, the first virtual object is first controlled to execute the action indicated by the manual control instruction, and then the second virtual object is controlled to execute the action indicated by the voice control instruction; or the second virtual object is first controlled to execute the action indicated by the voice control instruction, and then the first virtual object is controlled to execute the action indicated by the manual control instruction; or while the first virtual object is controlled to execute the action indicated by the manual control instruction, the second virtual object is also controlled to execute the action indicated by the voice control instruction.

Based on the above, in response to that the player controls the first virtual object through the manual control operation, the player also controls the second virtual objects through the voice control instruction, to avoid a case in which the main control switching operation switches between different virtual objects back and forth, and implement simultaneous control on the first virtual object and the second virtual objects in the same team in different modes, thereby improving the efficiency of controlling the virtual objects.

To reduce power consumption of the terminal and improve an accuracy of voice control, the terminal may receive the voice control instruction under a certain trigger condition. In some embodiments, the terminal receives the voice control instruction within a preset duration in response to the trigger operation on the voice command control.

In some embodiments, a voice command control is displayed in the virtual battle picture, and configured to control the terminal to receive the voice control instruction. The voice command control has two states: off state and on state. When the voice command control is in an off state, the terminal does not receive the voice control instruction, to avoid incorrect receiving and recognition of the voice sent by the player, thereby improving the accuracy of voice control and reducing power consumption of the terminal.

In response to that the trigger operation is executed on the voice command control, the voice command control changes from the off state to an on state, to receive the voice control instruction within the preset duration. The preset duration may be a duration set in advance, for example, 5 s. Alternatively, the preset duration may be a duration determined based on a current situation. The current situation includes at least one of information such as winning percentage, goals, assists, current offensive/defensive state, current scores, and current ball handler.

In some embodiments, the terminal controls the second virtual object to execute the action indicated by the voice control instruction.

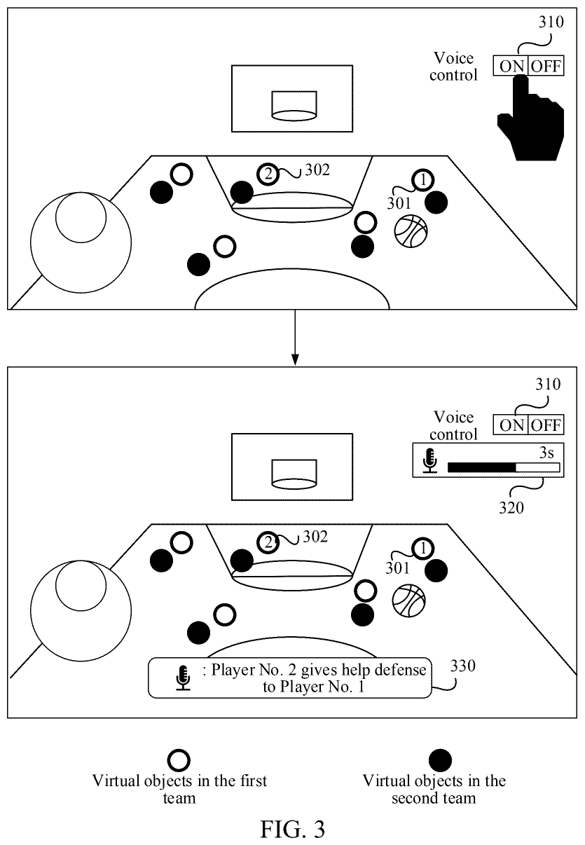

Referring to FIG. 3, FIG. 3 is a schematic diagram of receiving a voice control instruction according to an exemplary embodiment of the present disclosure.

As shown in FIG. 3, in a virtual battle picture, virtual objects in the first team are performing a basketball battle with virtual objects in the second team. The virtual objects in the first team controlled by a player include the first virtual object (shown by Player No. 1 301 in the figure) in a main control state and the second virtual object (shown by Player No. 2 302 in the figure).

A voice command control 310 is displayed in the virtual battle picture. When the player executes a trigger operation on the voice command control 310, the voice command control 310 changes from an off state (OFF) to an on state (ON).

In response to that a duration from a moment at which the trigger operation starts to a current moment does not reach a preset duration, a terminal continuously receives the voice control instruction inputted by the player through a voice input operation.

During a receiving process, the terminal may display a duration of receiving the voice in the virtual battle picture to prompt the player to complete the voice input operation within the preset duration. For example, within the preset duration, a voice input progress bar 320 is displayed on the virtual battle picture to prompt the user that a current voice input has lasted for 3 s.

In one embodiment, the terminal may further display a text prompt box 330 in the virtual battle picture to prompt the player of a content of an inputted voice control instruction. The content in the text prompt box 330 is a voice text obtained after executing text conversion on a received voice control instruction. For example, the voice text may be “Player No. 2 gives help defense to Player No. 1”.

By setting the preset duration, on one hand, the voice after the preset duration may not be received, to avoid incorrectly recognizing another voice of the player as the voice control instruction, thereby improving an accuracy of voice control, and on the other hand, power consumption of the terminal may also be reduced.

A current situation in the virtual battle picture may change from a moment at which the player triggers the voice command control to a moment at which the preset duration is reached. In some embodiments, the current situation may be determined based on an offensive/defensive state of a team. The offensive/defensive state includes one of an offensive state and a defensive state. For example, the offensive/defensive state of the first team may be switched from the offensive state to the defensive state, or from the defensive state to the offensive state.

In response to that offensive/defensive state switching does not occurs within the preset duration, the terminal may control the second virtual object to execute an action indicated by the voice control instruction.

In response to that the offensive/defensive state switching occurs within the preset duration, the voice control instruction inputted by the player before an offensive/defensive state switching time point is no longer applicable to the current situation. The offensive/defensive state switching time point is a time point at which a team switches from the defensive state to the offensive state, or from the offensive state to the defensive state. For example, before the offensive/defensive state switching time point, the first team is in the offensive state, and the voice control instruction inputted by the player is “The forward does a layup”. However, because the basketball is stolen by the second team, the offensive/defensive state of the first team is switched to the defensive state. In this case, in some embodiments, the terminal may ignore the voice control instruction. In some other embodiments, the terminal may determine an effective voice control instruction in the voice control instruction based on the offensive/defensive state switching time point; and control the second virtual object to execute an action indicated by the effective voice control instruction.

The offensive/defensive state switching time point may be determined based on a ball handler. For example, at the first moment, the ball handler is a virtual object A of the first team, and at the second moment, a virtual object B of the second team steals the ball from A, so the ball handler changes to B. In this case, the second moment may be determined as the offensive/defensive state switching time point.

The effective voice control instruction is at least a part of the voice control instruction. In one embodiment, the terminal may determine a voice control instruction that is within the preset duration and after the offensive/defensive state switching time point as the effective voice control instruction.

In one embodiment, the terminal may execute audio analysis on the voice control instruction based on the offensive/defensive state switching time point, and filter out voice information that does not match the offensive/defensive state after switching, to determine the effective voice control instruction. In some embodiments, the audio analysis may be implemented by using an audio software, a pre-trained audio processing model, a natural language processing model, or a large language model.

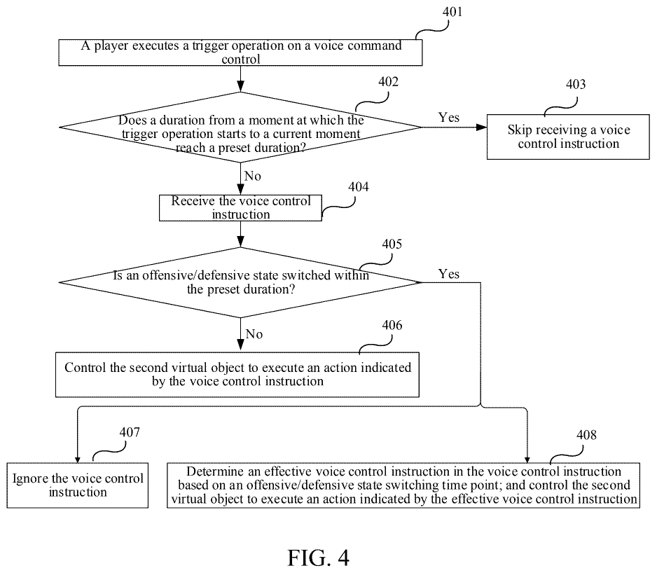

FIG. 4 is a flowchart of receiving a voice control instruction according to an exemplary embodiment of the present disclosure. The flowchart includes at least some of operation 401, operation 402, operation 403, operation 404, operation 405, operation 406, operation 407, and operation 408.

Operation 401: A player executes a trigger operation on a voice command control. For example, the player changes the voice command control 310 from an off state (OFF) to an on state (ON).

Operation 402: Determine whether a duration from a moment at which the trigger operation starts to a current moment reaches a preset duration.

In some embodiments, the preset duration is a duration set in advance, for example, 5 s. In some embodiments, the preset duration is set and determined by a user.

In response to that the preset duration is reached, operation 403 is executed.

Operation 403: Skip receiving a voice control instruction.

In response to that the preset duration is not reached, operation 404 is executed.

Operation 404: Receive the voice control instruction.

Operation 405: Determine whether an offensive/defensive state is switched within the preset duration.

In response to that the offensive/defensive state is not switched, operation 406 is executed.

Operation 406: Control the second virtual object to execute an action indicated by the voice control instruction.

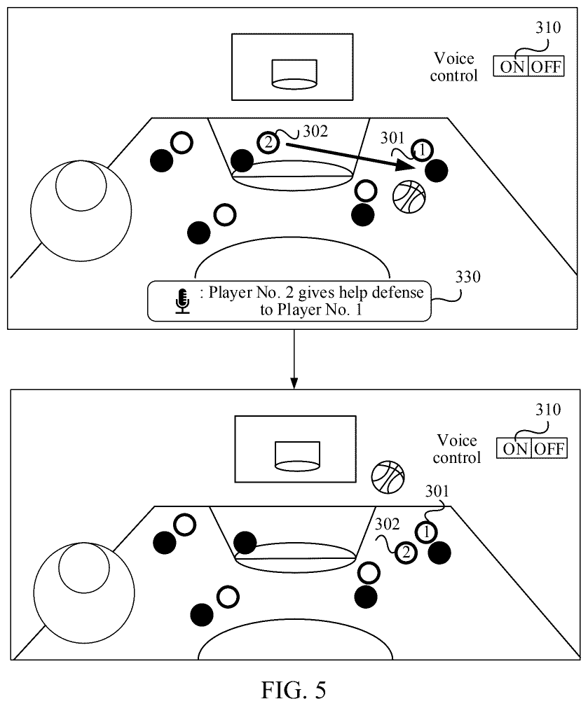

Referring to FIG. 5, FIG. 5 is a schematic diagram of controlling the second virtual object to execute an action indicated by the voice control instruction according to an exemplary embodiment of the present disclosure.

As shown in FIG. 5, the voice control instruction inputted by the player within the preset duration is “Player No. 2 gives help defense to Player No. 1”, and the offensive/defensive state of the first team within the preset duration is always a defensive state. Then, the terminal controls the second virtual object (shown by Player No. 2 302) to run to a position near Player No. 1 301 for defense. In this way, the second virtual object is controlled based on the voice.

In response to that the offensive/defensive state is switched, one of operation 407 or operation 408 may be executed.

Operation 407: Ignore the voice control instruction.

Operation 408: Determine an effective voice control instruction in the voice control instruction based on an offensive/defensive state switching time point; and control the second virtual object to execute an action indicated by the effective voice control instruction.

For example, at the second moment, Player No. 2 in the first team controlled by the player steals the ball from the second team, and the offensive/defensive state of the first team is switched from the defensive state to an offensive state. The voice control instruction inputted by the player is “Player No. 2 gives help defense to Player No. 1, . . . , Player No. 2 directly does a layup”. In this case, the terminal determines the second moment as the offensive/defensive state switching time point, determines the voice control instruction “No. 2 directly does a layup” inputted within the preset duration after the offensive/defensive state switching time point as the effective voice control instruction, and controls the second virtual object (Player No. 2) to perform a layup operation.

In this embodiment, the effective voice control instruction in the voice control instruction is determined based on the offensive/defensive state switching time point, so that when the offensive/defensive state of the team changes within the preset duration, the second virtual object is controlled based on the voice control instruction applicable to a current offensive/defensive state, thereby improving a control accuracy.

Exemplarily, to control the second virtual object based on the voice control instruction, key information may be extracted from the voice control instruction, and an action instruction may be generated based on an extracted key information, and the second virtual object in a target virtual object may be controlled to execute a target action based on the action instruction. The target action is an action indicated by the voice control instruction, that is, an action that the target virtual object needs to execute.

In some embodiments, the key information includes at least one of object information, behavior information, or tactical information extracted from the voice control instruction.

The object information may include information about the target virtual object executing the voice control instruction. The object information includes at least one of a name, a nickname, a code name, a role type, a number, and a position of the target virtual object.

For example, if the voice control instruction is “Player No. 2 gives help defense to Player No. 1 against the forward of the opposite team”, the target virtual object executing the voice control instruction is Player No. 2 in the first team.

In some embodiments, the target virtual object is one or more of the second virtual objects.

In some embodiments, the object information may further include information about other virtual objects that need to be determined to execute the voice control instruction. For example, the voice control instruction is “Player No. 2 gives help defense to Player No. 1 against the forward of the opposite team”. To execute the voice control instruction, the virtual object (Player No. 1) that Player No. 2 needs to help and the object (the forward of the opposite team) that Player No. 2 defends further need to be determined.

The behavior information is configured for indicating a target behavior of the target virtual object. The target behavior is a behavior corresponding to the target virtual object. In some embodiments, the target behavior includes at least one of body posture adjustment, offense, defense, layup, running, jumping, walking, offense and defense, and pick and roll.

For example, if the voice control instruction is “Player No. 2 gives help defense to Player No. 1 against the forward of the opposite team”, the behavior information is “help defense”, which is the target behavior corresponding to a target virtual object (Player No. 2).

The tactical information is a tactic corresponding to the target virtual object. For example, if the voice control instruction is “the guard and the forward cooperate to run a triangle offense”, the tactical information is “triangle offense”.

In some embodiments, the key information may further include other semantic information extracted from the voice control instruction, for example, position relationship information between virtual objects.

In some embodiments, the key information may further be obtained based on both other voice control instructions previously inputted and the voice control instruction currently inputted by the player, to increase a semantic extraction accuracy of the key information.

The action instruction is configured for indicating the target action executed by the target virtual object.

For example, if the voice control instruction is “Player No. 2 gives a help defense to Player No. 1 against the forward of the opposite team”, the action instruction generated based on the key information extracted from the voice control instruction includes: an instruction corresponding to that Player No. 2 moves to a position near Player No. 1 and that Player No. 2 performs a defense action against the forward of the opposite team.

After determining the action instruction, the terminal controls the target virtual object in the second virtual objects to execute the target action based on the action instruction.

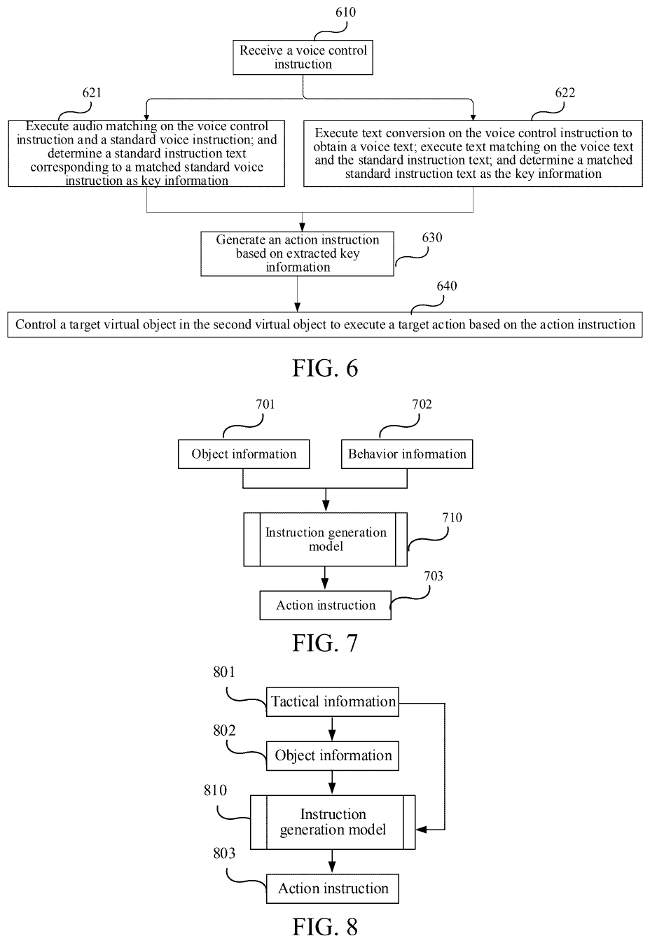

Referring to FIG. 6, FIG. 6 is a flowchart of extracting key information from the voice control instruction according to an exemplary embodiment of the present disclosure. The flowchart includes at least some of operation 610, operation 621, operation 622, operation 630, and operation 640.

Operation 610: Receive a voice control instruction.

For more content about receiving the voice control instruction, reference may be made to FIG. 4 and related descriptions thereof, and details are not described herein again.

After the voice control instruction is received, the key information may be extracted from the voice control instruction based on at least one method in operation 621 or operation 622.

Operation 621: Execute audio matching on the voice control instruction and a standard voice instruction; and determine a standard instruction text corresponding to a matched standard voice instruction as key information.

The standard voice instruction may include preset common voice instructions.

In one embodiment, the standard voice instruction includes voice instructions corresponding to an offensive state and a defensive state.

Exemplarily, the standard voice instructions corresponding to the offensive state include voice instructions corresponding to words such as “pick and roll”, “roll”, “fast break”, “positioning”, “three-point”, “shoot”, “pass”, and “alley-oop”.

Exemplarily, standard voice instructions corresponding to the defensive state include voice instructions corresponding to words such as “help defense”, “zone defense”, “team”, “cover”, “switch”, “zone defense”, “rebound”, and “steal”.

In some embodiments, a terminal may determine a current offensive/defensive state and execute audio matching on the voice control instruction and standard voice instructions conforming to the current offensive/defensive state. In some embodiments, the audio matching may be implemented based on a similarity between the voice control instruction and the standard voice instructions conforming to the current offensive/defensive state. The similarity may be a cosine similarity or a semantic similarity.

For example, when a ball handler is a virtual object of the first team, the first team is determined as being in an offensive state, and audio matching is executed on the voice control instruction and the standard voice instructions corresponding to the offensive state. When the ball handler is a virtual object of the second team, the first team is determined as being in a defensive state, and audio matching is executed on the voice control instruction and the standard voice instructions corresponding to the defensive state.

In one embodiment, standard voice instructions further include voice instructions corresponding to names, role types, numbers, or code names of different virtual objects.

Exemplarily, the standard voice instructions include voice instructions corresponding to words such as “forward”, “center”, “guard”, “C”, “G”, “F”, “position 1”, and “James Harden”.

In one embodiment, the standard voice instructions further include voice instructions corresponding to different tactics.

Exemplarily, the standard voice instructions include voice instructions corresponding to words such as “triangle offense”, “roll in pick and roll”, “focus on outside”, and “horns”.

In some embodiments, the standard voice instructions are obtained based on a historical voice instructions recorded for different users in advance, or obtained from public datasets, or extracted from public battle commentary videos.

Operation 622: Execute text conversion on the voice control instruction to obtain a voice text; execute text matching on the voice text and the standard instruction text; and determine a matched standard instruction text as the key information.

The standard instruction text may include common instruction texts set in advance.

Similarly, the standard instruction text may include instruction texts corresponding to the offensive state and the defensive state.

Exemplarily, standard instruction texts corresponding to the offensive state include texts corresponding to words such as “pick and roll”, “roll”, “fast break”, “positioning”, “three-point”, “shoot”, “pass”, and “alley-oop”.

Exemplarily, standard instruction texts corresponding to the defensive state include texts corresponding to words such as “help defense”, “zone defense”, “team”, “cover”, “switch”, “zone defense”, “rebound”, and “steal”.

In some embodiments, the terminal may determine the current offensive/defensive state and execute text matching on the voice text and standard instruction texts conforming to the current offensive/defensive state. In some embodiments, the text matching may be implemented based on a similarity between the voice text and the standard instruction texts conforming to the current offensive/defensive state. The similarity may be a cosine similarity or a semantic similarity.

For example, when the ball handler is a virtual object of the first team, the first team is determined as being in the offensive state, and text matching is executed on the voice text and the standard instruction texts corresponding to the offensive state. When the ball handler is a virtual object of the second team, the first team determined as being in the defensive state, and text matching is executed on the voice text and the standard instruction texts corresponding to the defensive state.

Similarly, the standard instruction texts may include texts corresponding to names, role types, numbers, or code names of different virtual objects, and texts corresponding to names of different tactics.

Operation 630: Generate an action instruction based on extracted key information.

In one embodiment, the action instruction may be generated based on the key information by using an instruction generation model. For more content about the instruction generation model, reference may be made to FIG. 7, FIG. 8, and related descriptions thereof, and details are not described herein again.

Operation 640: Control a target virtual object in the second virtual object to execute a target action based on the action instruction.

In this embodiment, audio matching is executed on the voice control instruction and the standard voice instruction, or text matching is executed on the voice text and the standard instruction text, to extract the key information from the voice control instruction, so as to subsequently determine the action instruction for controlling the second virtual object. The current offensive/defensive state is determined, and matching is executed based on the standard voice instructions or standard instruction texts conforming to the current offensive/defensive state, so that matching accuracy can be further improved.

In some scenarios, the key information extracted from the voice control instruction may include only the object information and the behavior information, only the tactical information, or all of the object information, the behavior information, and the tactical information.

To generate the action instruction, in a possible mode, the action instruction may be predicted based on the object information and the behavior information by using the instruction generation model.

Referring to FIG. 7, FIG. 7 is a schematic diagram of generating an action instruction by an instruction generation model according to an exemplary embodiment of the present disclosure.

As shown in FIG. 7, in response to that key information includes object information 701 and behavior information 702, the object information and the behavior information are inputted into an instruction generation model 710 to obtain an action instruction 703 outputted by the instruction generation model 710.

The object information is configured for indicating a target virtual object, and the behavior information is configured for indicating a target behavior of the target virtual object.

Exemplarily, if a voice control instruction is “Player No. 2 gives help defense against the forward of the opposite team”, the object information extracted from the voice control instruction includes “Player No. 2”, and the behavior information includes “help defense”. The action instruction generated based on the object information and the behavior information by using the instruction generation model controls Player No. 2 to give help defense.

In some embodiments, the instruction generation model is a neural network model, for example, at least one of convolutional neural networks (CNNs) or a deep-learning neural network (DNN).

To generate the action instruction, in a possible mode, the action instruction may be predicted based on the tactical information and the object information by using the instruction generation model. Exemplarily, training data of the instruction generation model is sample tactical information and sample object information. The sample tactical information and the sample object information are annotated with sample action instructions. In a training phase, the sample tactical information and the sample object information are simultaneously inputted to a to-be-trained instruction generation model to obtain predicted action instructions outputted by the to-be-trained instruction generation model, and taking reducing a difference between the sample action instructions and the predicted action instructions as a training target, model parameters of the to-be-trained instruction generation model are adjusted to obtain the instruction generation model.

Referring to FIG. 8, FIG. 8 is a schematic diagram of generating an action instruction by an instruction generation model according to another exemplary embodiment of the present disclosure. As shown in FIG. 8, in response to that key information includes tactical information 801, object information 802 may be first determined based on the tactical information 801, and then the object information 802 and the tactical information 801 are inputted to an instruction generation model 810 to obtain action instructions 803 outputted by the instruction generation model 810. Exemplarily, training data of the instruction generation model is sample tactical information and sample object information. The sample object information is determined based on the sample tactical information, and the sample tactical information is annotated with sample action instructions. In a training phase, the sample tactical information and the sample object information are inputted to a to-be-trained instruction generation model to obtain predicted action instructions outputted by the to-be-trained instruction generation model, and taking reducing a difference between the sample action instructions and the predicted action instructions as a training target, model parameters of the to-be-trained instruction generation model are adjusted to obtain the instruction generation model.

A method for determining the object information based on the tactical information may include at least one of the following modes.
(1) The object information is determined based on the tactical information and role types of virtual objects.

In some embodiments, when the role types of the virtual objects are applicable to the tactical information, the virtual objects are determined as target virtual objects indicated by the object information. A correspondence is preset between the role types of the virtual objects and the tactical information to which the virtual objects are applicable.

For example, in response to that the tactical information is “triangle offense”, the guard, the center, and the forward need to be controlled, to implement the tactic of triangle offense. Therefore, three virtual objects, one of which the role type is the guard, one of which the role type is the center, and one of which the role type is the forward, may be determined from the second virtual objects of the first team as the target virtual objects.
(2) The object information is determined based on the tactical information and current locations of the virtual objects.

For example, if the tactical information is “focus on outside”, the virtual object closest to the sideline at the current location among the second virtual objects in the first team may be determined as the target virtual object indicated by the object information.

In this embodiment, by using the instruction generation model, the action instruction corresponding to the voice control instruction may be generated based on the object information and the behavior information, or based on the tactical information and the object information, to control the second virtual objects.

In one embodiment, the key information may include behavior information, and does not include object information. For example, in response to that the voice control instruction inputted by a player is “defend against the forward of the opposite team”, because the subject is missing, the key information extracted through text matching or audio matching lacks the object information.

In response to that the key information includes the behavior information and does not include the object information, the terminal may determine the target virtual object based on the behavior information and the object information of each of the second virtual objects.

A matching degree between the object information and the behavior information of the target virtual object is higher than a matching degree between the object information and the behavior information of the other second virtual objects.

In some embodiments, the object information of the second virtual object may include at least one of the role type or the current location of the second virtual object.

After determining the target virtual object, the terminal may supplement the key information based on the object information of the target virtual object.

For example, the key information extracted from “defend against the forward of the opposite team” is supplemented as the object information “position 2” and the action information “defense”.

A method for determining the object information based on the behavior information may include at least one of the following modes.
(1) The behavior information and role types of a plurality of second virtual objects are inputted into the first object determining model to obtain role matching degrees of the plurality of second virtual objects for the behavior information, that are outputted by the first object determining model; and the second virtual object with the highest role matching degree is determined as the target virtual object indicated by the object information.

For example, the behavior information “layup” and the role types (position 2: guard; position 3: center; position 4 and position 5: forwards) corresponding to all the second virtual objects in the first team are inputted to the first object determining model to obtain the role matching degree of each second virtual object, namely 10%, 20%, 30%, and 40%, and then the virtual object corresponding to position 5 is determined as the target virtual object indicated by the object information.

In one embodiment, the first object determining model may be trained based on historical battle records of the first team. Exemplarily, training data of the first object determining model includes sample behavior information and role types corresponding to sample virtual objects. For each piece of sample behavior information, a sample role matching degree of the role type corresponding to the sample virtual object for the sample behavior information is annotated. The sample role matching degree may be annotated based on historical battle records. In a training phase, the sample behavior information and the role types corresponding to the sample virtual objects are inputted to a to-be-trained first object determining model to obtain predicted role matching degrees of the to-be-trained first object determining model, taking reducing an error between the sample role matching degrees and the predicted role matching degrees as a training target, model parameters of the to-be-trained first object determining model are adjusted to obtain the first object determining model.
(2) The behavior information and current locations of the plurality of second virtual objects are inputted into the second object determining model to obtain location matching degrees of the plurality of second virtual objects for the behavior information, that are outputted by the second object determining model; and the second virtual object with the highest location matching degree is determined as the target virtual object indicated by the object information.

For example, the behavior information “rebound” and the current locations (position 2: backcourt; position 3: mid-court; position 4: frontcourt; position 5: mid-court) corresponding to all the second virtual objects in the first team are inputted to the second object determining model to obtain the location matching degree of each second virtual object, namely 10%, 15%, 60%, and 15%, and then the virtual object corresponding to position 4 is determined as the target virtual object indicated by the object information.

In one embodiment, the second object determining model may be trained based on historical battle records of the first team. Exemplarily, training data of the second object determining model includes sample behavior information and current locations corresponding to the sample virtual objects. For each piece of sample behavior information, a sample location matching degree of the current location corresponding to the sample virtual object for the sample behavior information is annotated. The sample location matching degree may be annotated based on historical battle records. In a training phase, the sample behavior information and the current locations corresponding to the sample virtual objects are inputted to a to-be-trained second object determining model to obtain predicted location matching degrees of the to-be-trained second object determining model, and taking reducing an error between the sample location matching degrees and the predicted location matching degrees as the training target, model parameters of the to-be-trained second object determining model are adjusted to obtain the second object determining model.

In one embodiment, the key information may include object information, and does not include behavior information. For example, in response to that the voice control instruction inputted by the player is “position 2! position 2!”, because the verb is missing, the key information extracted through text matching or audio matching lacks the behavior information.

In response to that the key information includes the object information and does not include the behavior information, the terminal may determine the target behavior based on the object information and behavior information of each of candidate behaviors. The target behavior is one of a plurality of candidate behaviors.

A matching degree between the target behavior and the target virtual object is higher than a matching degree between the other candidate behaviors and the target virtual object.

In some embodiments, the behavior information of each of the candidate behaviors includes a probability or a success rate that the candidate behavior is executed by different virtual objects in the historical battle records.

In one embodiment, the success rate that the target virtual object executes each candidate behavior in the historical battle records may be determined based on the historical battle records, and a candidate behavior with the highest success rate is determined as the target behavior.

In another embodiment, a matching degree between each candidate behavior and the target virtual object may be determined by using a target behavior prediction model based on a current situation, a current location of each virtual object, each candidate behavior, and the target virtual object. Exemplarily, training data of the target behavior prediction model includes sample situations, current locations of sample virtual objects, and sample behaviors. For each sample situation, a sample matching degree of the current location of the sample virtual object for each sample behavior is annotated. The sample matching degree may be annotated based on the historical battle records. In a training phase, the sample situations, the current locations of the sample virtual objects, and the sample behaviors are inputted to a to-be-trained target behavior prediction model to obtain predicted matching degrees of the to-be-trained target behavior prediction model, taking reducing an error between the sample matching degrees and the predicted matching degrees as the training target, model parameters of the to-be-trained target behavior prediction model are adjusted to obtain the target behavior prediction model.

The current situation includes information such as a current offensive/defensive state, current scores, and a current ball handler.

After determining the target behavior, the terminal may supplement the key information based on the behavior information of the target behavior. In some embodiments, the key information is at least one of the object information and the action information of the target virtual object related to the target behavior.

For example, the key information extracted from “position 2! position 2!” is supplemented as the object information “position 2” and the action information “defense”.

In this embodiment, in response to that the key information lacks the object information or the behavior information, the key information may be supplemented by computing matching degrees between different virtual objects and the behavior information or computing matching degrees between different candidate behaviors and the target virtual object, so that the action instruction generated by the instruction generation model is more accurate, thereby improving an accuracy of controlling the second virtual objects by the terminal.

After the key information is supplemented, supplemented object information or behavior information may be displayed to the player, and after the player gives confirmation, the action instruction generated based on the supplemented key information is executed, thereby further improving the accuracy of controlling the second virtual objects.

In some embodiments, the terminal displays an object confirmation control, and supplements the key information based on the object information of the target virtual object in response to a confirmation operation on the object confirmation control. In some embodiments, the terminal displays the object confirmation control in a virtual battle picture.

The object confirmation control is configured to confirm whether the target virtual object responds to the voice control instruction.

In one embodiment, the player may execute a determining operation by clicking/tapping, double-clicking/tapping, or long-pressing the object confirmation control (that is, execute confirmation by manual control operations).

In another embodiment, the player may further indicate a confirmation operation on the object confirmation control by inputting words such as “confirm the object” with voice (that is, confirm by voice control operations).

In one embodiment, the terminal may further display a confirmation prompt bar in the virtual battle picture, and display, in the confirmation prompt bar, a prompt text corresponding to prompting the player to confirm whether the target virtual object responds to the voice control instruction, so as to prompt the player to confirm whether the target virtual object responds to the voice control instruction. The confirmation prompt bar may be fixedly displayed at a lower left position or a lower right position of the virtual battle picture, or may be displayed in a mobile mode in the virtual battle picture. For example, the prompt text in the confirmation prompt bar may be a question “Executed by position 2?”.

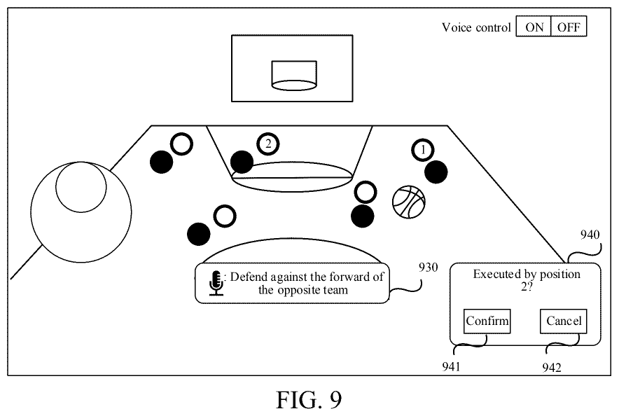

Referring to FIG. 9, FIG. 9 is a schematic diagram of executing a confirmation operation on an object confirmation control according to an exemplary embodiment of the present disclosure. As shown in FIG. 9, a voice text “defend against the forward of the opposite team” corresponding to a voice control instruction is displayed in a text prompt box 930, and key information extracted from the voice control instruction includes action information “defense” and does not include object information.

Therefore, after a terminal determines the object information “position 2”, the question “Executed by position 2?” may be displayed to a player through a confirmation prompt bar 940.

In response to that the player executes a confirmation operation on an object confirmation control 941, the terminal may supplement the key information extracted from the voice control instruction, and supplement the object information as “position 2”.

In response to that the player executes a cancel operation on an object confirmation control 942, the terminal may display another virtual object with the second highest matching degree for the player to re-confirm, or display a supplementation prompt to the player, so that the player further performs supplementation with voice.

In some embodiments, the terminal displays a behavior confirmation control, and supplements the key information based on the behavior information of a target behavior in response to a confirmation operation on the behavior confirmation control. In some embodiments, the terminal displays the behavior confirmation control in a virtual battle picture.

The behavior confirmation control is configured to confirm whether to execute the target behavior.

In one embodiment, the player may execute a determining operation by clicking/tapping, double-clicking/tapping, or long-pressing the behavior confirmation control (that is, confirm by manual control operations).

In another embodiment, the player may further indicate a confirmation operation on the behavior confirmation control by inputting words such as “confirm the behavior” with voice (that is, confirm by voice control operations).

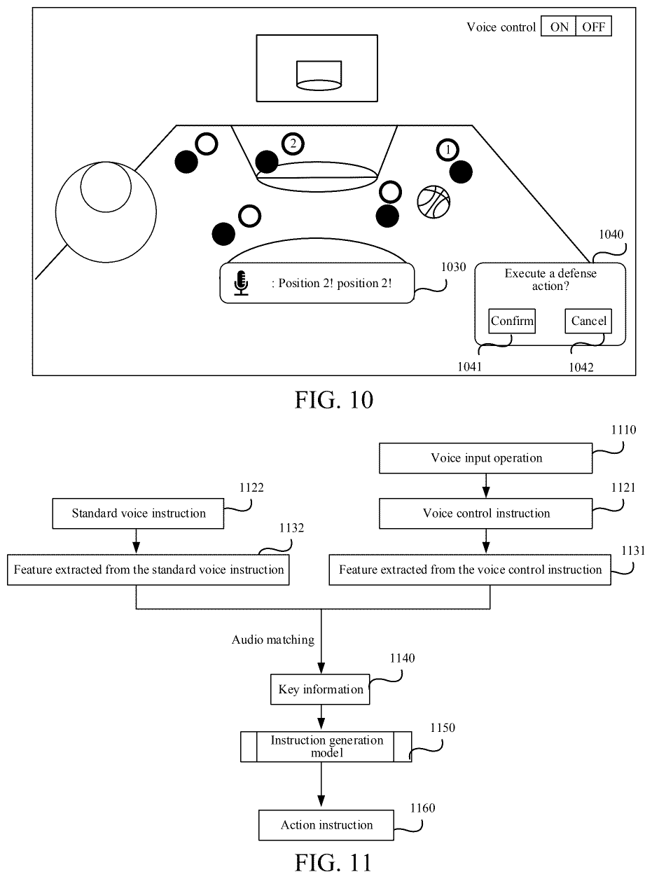

Referring to FIG. 10, FIG. 10 is a schematic diagram of executing a confirmation operation on a behavior confirmation control according to an exemplary embodiment of the present disclosure. As shown in FIG. 10, a voice text “position 2! position 2!” corresponding to a voice control instruction is displayed in a text prompt box 1030, and key information extracted from the voice control instruction includes object information “position 2” and does not include behavior information.

Therefore, after a terminal determines the behavior information “defense”, a question “Execute a defense action?” may be displayed to a player through a confirmation prompt bar 1040.

In response to that the player executes a confirmation operation on a behavior confirmation control 1041, the terminal may supplement the key information extracted from the voice control instruction, and supplement the behavior information as “defense”.

In response to that the player executes a cancel operation on a behavior confirmation control 1042, the terminal may display another candidate behavior with the second highest matching degree for the player to re-confirm, or display a supplementation prompt to the player, so that the player further performs supplementation with voice.

In this embodiment, when the key information is incomplete, to-be-supplemented behavior information or object information is displayed to the player, to supplement the key information when the player gives confirmation, so that the key information is more accurate, thereby further improving an accuracy of controlling the second virtual objects.

Because different virtual objects have different factors such as role types and levels, different virtual objects have different execution degrees for the same target behavior. For example, in response to that an action instruction is instructing a target virtual object to do a layup operation, different second virtual objects have different layup percentages. Alternatively, in response to that the action instruction is instructing the target virtual object to perform a pick and roll operation, different second virtual objects also have different success rates of pick and roll.

Therefore, to improve a realness of a game scenario, in some embodiments, an instruction execution degree of the target virtual object may be determined, instruction perturbation processing may be executed on the action instruction based on the instruction execution degree, and the target virtual object is controlled to execute a target action based on an action instruction after the perturbation processing. The instruction perturbation processing is a mode of optimizing the action instruction, including optimizing at least one of attributes such as an execution duration, an execution location, or an execution success rate of the target action indicated by the action instruction.

An effect of executing the target action based on an action instruction before the perturbation processing is better than an effect of executing the target action based on the action instruction after the perturbation processing.

In one embodiment, the instruction execution degree may be determined based on a matching degree between the target action and a role type of the target virtual object. A matching degree between the target action and the role type of the target virtual object has a positive correlation with the instruction execution degree, and a higher matching degree indicates a larger instruction execution degree. The matching degree may be obtained through prediction based on a neural network model, or may be obtained based on a preset matching degree correspondence between the target action and the role type of the target virtual object.

For example, in response to that the role type of the target virtual object is forward and the target action is defense, a relatively low instruction execution degree (for example, 50%) may be determined. In response to that the role type is forward and the target action is offense, a relatively high instruction execution degree (for example, 90%) may be determined.

In one embodiment, the executing instruction perturbation processing on the action instruction may include modifying at least one of attributes such as an execution duration, an execution location, or an execution success rate of the target action.

For example, in response to that the role type of the target virtual object is forward and the target action is defense, the instruction execution degree is determined to be 50%. In this case, the terminal may obtain the defense success rate by halving a default value, to implement more real control on the second virtual object.

Referring to FIG. 11, FIG. 11 is a schematic diagram of a virtual object control method according to an exemplary embodiment of the present disclosure.

As shown in FIG. 11, a player inputs a voice control instruction 1121 to a terminal through a voice input operation 1110. The terminal executes feature extraction on the voice control instruction 1121 to obtain a feature 1131 extracted from the voice control instruction 1121. Meanwhile, the terminal executes feature extraction on a standard voice instruction 1122 to obtain a feature 1132 extracted from the standard voice instruction 1122.

In one embodiment, before the feature extraction, a preprocessing operation is included, for example, a preprocessing operation such as voice amplitude standardization, frequency response correction, and framing processing.

In one embodiment, the feature extraction includes extracting at least one feature from linear parameters, such as a formant frequency and an amplitude, of an audio signal. A person skilled in the art may understand that the feature extraction may further include extracting other features of the audio signal, for example, a signal type and a signal length. This is not limited in this embodiment of the present disclosure.

After audio matching is executed on the feature 1131 extracted from the voice control instruction 1121 and the feature 1132 extracted from the standard voice instruction 1122, key information 1140 corresponding to the voice control instruction is obtained. The terminal generates an action instruction 1160 based on the key information 1140 by using an instruction generation model 1150. The action instruction 1160 is configured for controlling a target virtual object to execute a target action. For more content about the instruction generation model, reference may be made to FIG. 7, FIG. 8, and related descriptions thereof, and details are not described herein again.

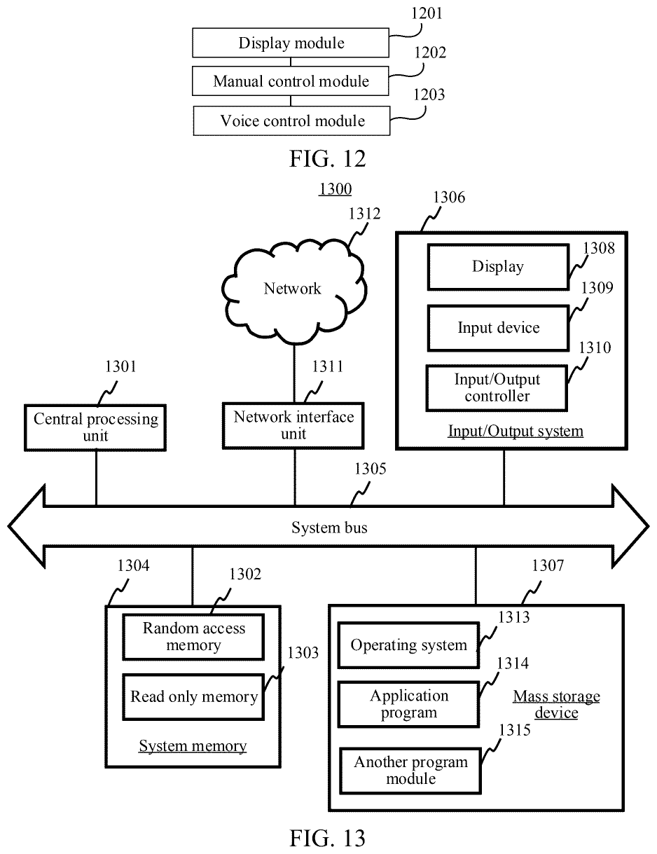

Referring to FIG. 12, FIG. 12 is a structural block diagram of a virtual object control apparatus according to an exemplary embodiment of the present disclosure. The apparatus further includes:
a display module 1201, configured to display the first virtual object and the second virtual object, the first virtual object being a virtual object in a main control state, and the second virtual object being a non-player controlled virtual object belonging to a same team as the first virtual object;
a manual control module 1202, configured to control, in response to receiving a manual control instruction, the first virtual object to execute an action indicated by the manual control instruction; and
a voice control module 1203, configured to control, in response to receiving a voice control instruction, the second virtual object to execute an action indicated by the voice control instruction.

In some embodiments, the voice control module 1203 is configured to:
receive the voice control instruction in response to a trigger operation on a voice command control; and
control the second virtual object to execute the action indicated by the voice control instruction.

In some embodiments, the voice control module 1203 is configured to:
receive the voice control instruction within a preset duration in response to the trigger operation on the voice command control.

In some embodiments, the voice control module 1203 is configured to:
control, in response to that offensive/defensive state switching does not occurs within the preset duration, the second virtual object to execute the action indicated by the voice control instruction.

In some embodiments, the voice control module 1203 is configured to:
ignore the voice control instruction in response to that the offensive/defensive state switching occurs within the preset duration;
or
determine an effective voice control instruction in the voice control instruction based on an offensive/defensive state switching time point; and control the second virtual object to execute an action indicated by the effective voice control instruction.

In some embodiments, the voice control module 1203 is configured to:
extract key information from the voice control instruction;
generate an action instruction based on extracted key information, the action instruction indicating a target action executed by a target virtual object, and the target virtual object being one or more of second virtual objects; and
control the target virtual object in the second virtual objects to execute the target action based on the action instruction.

In some embodiments, the voice control module 1203 is configured to:
execute audio matching on the voice control instruction and a standard voice instruction; and determine a standard instruction text corresponding to a matched standard voice instruction as the key information;
or
execute text conversion on the voice control instruction to obtain a voice text; execute text matching on the voice text and a standard instruction text; and determine a matched standard instruction text as the key information.

In some embodiments, the voice control module 1203 is configured to:
determine a current offensive/defensive state; and
execute audio matching on the voice control instruction and a standard voice instruction conforming to the current offensive/defensive state.

In some embodiments, the voice control module 1203 is configured to:
determine the current offensive/defensive state; and
execute text matching on the voice text and a standard instruction text conforming to the current offensive/defensive state.

In some embodiments, the voice control module 1203 is configured to:
input, in response to that the key information includes object information and behavior information, the object information and the behavior information into an instruction generation model to obtain an action instruction outputted by the instruction generation model, the object information indicating the target virtual object, and the behavior information indicating a target behavior of the target virtual object;
or
determine, in response to that the key information includes tactical information, object information based on the tactical information; and input the object information and the tactical information into the instruction generation model to obtain the action instruction outputted by the instruction generation model, the object information indicating the target virtual object.

In some embodiments, in response to that the key information includes the behavior information and does not include the object information, the voice control module 1203 is configured to:
determine the target virtual object based on the behavior information and object information of each of the second virtual objects, a matching degree between the object information and the behavior information of the target virtual object being higher than a matching degree between object information and behavior information of the other second virtual objects; and
supplement the key information based on the object information of the target virtual object.

In some embodiments, after the determining the target virtual object, the display module 1201 is configured to:
display an object confirmation control, the object confirmation control being configured for determining whether the target virtual object responds to the voice control instruction.

In some embodiments, the voice control module 1203 is configured to:
supplement the key information based on the object information of the target virtual object in response to a confirmation operation on the object confirmation control.

In some embodiments, in response to that the key information includes the object information and does not include the behavior information, the voice control module 1203 is configured to:
determine the target behavior based on the object information and behavior information of each of candidate behaviors, a matching degree between the target behavior and the target virtual object being higher than a matching degree between the other candidate behaviors and the target virtual object; and
supplement the key information based on the behavior information of the target behavior.

In some embodiments, after the determining the target behavior, the display module 1201 is configured to:
display a behavior confirmation control, the behavior confirmation control being configured for confirming whether to execute the target behavior.

In some embodiments, the voice control module 1203 is configured to:
supplement the key information based on the behavior information of the target behavior in response to a confirmation operation on the behavior confirmation control.

In some embodiments, the voice control module 1203 is configured to:
determine an instruction execution degree of the target virtual object;
execute instruction perturbation processing on the action instruction based on the instruction execution degree; and
control the target virtual object to execute the target action based on an action instruction after the perturbation processing, an effect of executing the target action based on an action instruction before the perturbation processing being better than an effect of executing the target action based on the action instruction after the perturbation processing.

In some embodiments, a virtual battle picture includes the first virtual object and the second virtual object, and the virtual battle picture is a virtual team ball battle picture.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

Refer to FIG. 13, FIG. 13 is a schematic structural diagram of a computer device according to an exemplary embodiment of the present disclosure. The computer device may be implemented as the terminal or the server in the foregoing embodiments. The terminal includes but is not limited to a smartphone, a notebook computer, a desktop computer, an in-vehicle terminal, and the like. The terminal may also be referred to as another name such as a user equipment or a portable terminal.

Specifically, the computer device 1300 includes a central processing unit (CPU) 1301, a system memory 1304 including a random access memory 1302 and a read only memory 1303, and a system bus 1305 connecting the system memory 1304 and the central processing unit 1301. The computer device 1300 further includes a basic input/output (I/O) system 1306 assisting in information transmission between components in a computer, and a mass storage device 1307 configured to store an operating system 1313, an application program 1314, and another program module 1315.

The basic I/O system 1306 includes a display 1308 configured to display information and an input device 1309 such as a mouse or a keyboard that is configured to input information by a user. The display 1308 and the input device 1309 are both connected to the CPU 1301 by using an input/output controller 1310 connected to the system bus 1305. The basic I/O system 1306 may further include the input/output controller 1310 to be configured to receive and process inputs from a plurality of other devices such as a keyboard, a mouse, and an electronic stylus. Similarly, the input/output controller 1310 further provides an output to a display screen, a printer, or another type of output device.

The mass storage device 1307 is connected to the CPU 1301 by using a mass storage controller (not shown) connected to the system bus 1305. The mass storage device 1307 and a computer-readable medium associated therewith provide non-volatile storage for the computer device 1300. That is, the mass storage device 1307 may include the computer-readable medium (not shown) such as a hard disk or a drive.

Without loss of generality, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a random access memory (RAM), a read only memory (ROM), a flash memory or another solid-state storage technology, a compact disc read-only memory (CD-ROM), a digital versatile disc (DVD) or another optical memory, a magnetic cassette, a magnetic tape, a magnetic disk memory, or another magnetic storage device. Certainly, a person skilled in the art may learn that the computer storage medium is not limited to the foregoing several types. The foregoing system memory 1304 and the mass storage device 1307 may be collectively referred to as a memory.

The memory has one or more programs stored therein, the one or more programs are configured for being executed by one or more CPUs 1301, the one or more programs include instructions configured for implementing the foregoing methods, and the CPU 1301 executes the one or more programs to implement the methods provided in the foregoing method embodiments.

According to the embodiments of the present disclosure, the computer device 1300 may further be connected, through a network such as the Internet, to a remote computer on the network to run. That is, the computer device 1300 may be connected to a network 1312 by using a network interface unit 1311 connected to the system bus 1305, or may be connected to another type of network or a remote computer system (not shown) by using a network interface unit 1311.

The memory also includes one or more programs, the one or more programs are stored in the memory, and the one or more programs include operations for performing the method provided in the embodiment of the present disclosure and executed by the computer device.

An embodiment of the present disclosure further provides a computer-readable storage medium, having at least one instruction stored therein, and the at least one instruction is loaded and executed by a processor to implement the method described in any of the above embodiments.

In some embodiments, the computer-readable storage medium may include: a ROM, a RAM, a solid state drive (SSD), an optical disk, and the like. The RAM may include a resistance random access memory (ReRAM) and a dynamic random access memory (DRAM).

An embodiment of the present disclosure provides a computer program product, including a computer instruction, and the computer instruction is stored in a computer-readable storage medium. A processor of the computer device reads the computer instruction from the computer-readable storage medium, and the processor executes the computer instruction, to cause the computer device to execute the method in the foregoing embodiment.

A person of ordinary skill in the art may understand that all or some of the steps of the foregoing embodiments may be implemented by hardware, or may be implemented by a program instructing related hardware. The program may be stored in a computer-readable storage medium. The storage medium may be a read only memory, a magnetic disk, an optical disc, or the like.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A virtual object control method, executed by a terminal, the method comprising:
displaying the first virtual object and the second virtual object, the first virtual object being a virtual object in a main control state, and the second virtual object being a non-player controlled virtual object belonging to a same team as the first virtual object;
controlling, in response to receiving a manual control instruction, the first virtual object to execute an action indicated by the manual control instruction; and
controlling, in response to receiving a voice control instruction, the second virtual object to execute an action indicated by the voice control instruction.

2. The method according to claim 1, wherein the controlling, in response to receiving a voice control instruction, the second virtual object to execute an action indicated by the voice control instruction comprises:
receiving the voice control instruction in response to a trigger operation on a voice command control; and
controlling the second virtual object to execute the action indicated by the voice control instruction.

3. The method according to claim 2, wherein the receiving the voice control instruction in response to a trigger operation on a voice command control comprises:
receiving the voice control instruction within a preset duration in response to the trigger operation on the voice command control.

4. The method according to claim 1, wherein the controlling the second virtual object to execute the action indicated by the voice control instruction comprises:
controlling, in response to that offensive/defensive state switching does not occurs within the preset duration, the second virtual object to execute the action indicated by the voice control instruction.

5. The method according to claim 1, further comprising:
ignoring the voice control instruction in response to that the offensive/defensive state switching occurs within a preset duration;
or
determining an effective voice control instruction in the voice control instruction based on an offensive/defensive state switching time point; and controlling the second virtual object to execute an action indicated by the effective voice control instruction.

6. The method according to claim 1, wherein the controlling the second virtual object to execute the action indicated by the voice control instruction comprises:
extracting key information from the voice control instruction;
generating an action instruction based on extracted key information, the action instruction indicating a target action executed by a target virtual object, and the target virtual object being one or more of the second virtual objects; and
controlling the target virtual object in the second virtual objects to execute the target action based on the action instruction.

7. The method according to claim 6, wherein the extracting key information from the voice control instruction comprises:
executing audio matching on the voice control instruction and a standard voice instruction; and determining a standard instruction text corresponding to a matched standard voice instruction as the key information;
or
executing text conversion on the voice control instruction to obtain a voice text; executing text matching on the voice text and a standard instruction text; and determining a matched standard instruction text as the key information.

8. The method according to claim 7, wherein the executing audio matching on the voice control instruction and a standard voice instruction comprises:
determining a current offensive/defensive state; and
executing audio matching on the voice control instruction and a standard voice instruction conforming to the current offensive/defensive state; and
the executing text matching on the voice text and a standard instruction text comprises:
determining the current offensive/defensive state; and
executing text matching on the voice text and a standard instruction text conforming to the current offensive/defensive state.

9. The method according to claim 6, wherein the generating an action instruction based on extracted key information comprises:
inputting, in response to that the key information comprises object information and behavior information, the object information and the behavior information into an instruction generation model to obtain an action instruction outputted by the instruction generation model, the object information indicating the target virtual object, and the behavior information indicating a target behavior of the target virtual object;
or
determining, in response to that the key information comprises tactical information, object information based on the tactical information; and inputting the object information and the tactical information into the instruction generation model to obtain the action instruction outputted by the instruction generation model, the object information indicating the target virtual object.

10. The method according to claim 9, wherein in response to that the key information comprises the behavior information and does not comprise the object information, the method further comprises:
determining the target virtual object based on the behavior information and object information of the second virtual objects, a matching degree between the object information and the behavior information of the target virtual object being higher than a matching degree between object information and behavior information of the other second virtual objects; and
supplementing the key information based on the object information of the target virtual object.

11. The method according to claim 10, further comprising:
displaying an object confirmation control, the object confirmation control being configured to determine whether the target virtual object responds to the voice control instruction; and
the supplementing the key information based on the object information of the target virtual object comprises:
supplementing the key information based on the object information of the target virtual object in response to a confirmation operation on the object confirmation control.

12. The method according to claim 9, wherein in response to that the key information comprises the object information and does not comprise the behavior information, the method further comprises:
determining the target behavior based on the object information and behavior information of candidate behaviors, a matching degree between the target behavior and the target virtual object being higher than a matching degree between the other candidate behaviors and the target virtual object; and
supplementing the key information based on the behavior information of the target behavior.

13. The method according to claim 12, further comprising:
displaying a behavior confirmation control, the behavior confirmation control being configured for confirming whether to execute the target behavior; and
the supplementing the key information based on the behavior information of the target behavior comprises:
supplementing the key information based on the behavior information of the target behavior in response to a confirmation operation on the behavior confirmation control.

14. The method according claim 6, wherein the controlling the target virtual object in the second virtual objects to execute the target action based on the action instruction comprises:
determining an instruction execution degree of the target virtual object;
executing instruction perturbation processing on the action instruction based on the instruction execution degree; and
controlling the target virtual object to execute the target action based on an action instruction after the perturbation processing, an effect of executing the target action based on an action instruction before the perturbation processing being better than an effect of executing the target action based on the action instruction after the perturbation processing.

15. The method according to claim 1, wherein a virtual battle picture comprises the first virtual object and the second virtual object, and the virtual battle picture is a virtual team ball battle picture.

16. A virtual object control apparatus, comprising:
a processor and a memory, the memory having at least one instruction stored therein, and the processor being configured, when executing the at least one instruction, to implement:
displaying the first virtual object and the second virtual object, the first virtual object being a virtual object in a main control state, and the second virtual object being a non-player controlled virtual object belonging to a same team as the first virtual object;
controlling, in response to receiving a manual control instruction, the first virtual object to execute an action indicated by the manual control instruction; and
controlling, in response to receiving a voice control instruction, the second virtual object to execute an action indicated by the voice control instruction.

17. The apparatus according to claim 16, wherein the controlling, in response to receiving a voice control instruction, the second virtual object to execute an action indicated by the voice control instruction comprises:
receiving the voice control instruction in response to a trigger operation on a voice command control; and
controlling the second virtual object to execute the action indicated by the voice control instruction.

18. The apparatus according to claim 17, wherein the receiving the voice control instruction in response to a trigger operation on a voice command control comprises:
receiving the voice control instruction within a preset duration in response to the trigger operation on the voice command control.

19. The apparatus according to claim 16, wherein the controlling the second virtual object to execute the action indicated by the voice control instruction comprises:
extracting key information from the voice control instruction;
generating an action instruction based on extracted key information, the action instruction indicating a target action executed by a target virtual object, and the target virtual object being one or more of the second virtual objects; and
controlling the target virtual object in the second virtual objects to execute the target action based on the action instruction.

20. A non-transitory computer-readable storage medium, having at least one instruction stored therein, the instruction being loaded and executed by a processor to implement:
displaying the first virtual object and the second virtual object, the first virtual object being a virtual object in a main control state, and the second virtual object being a non-player controlled virtual object belonging to a same team as the first virtual object;
controlling, in response to receiving a manual control instruction, the first virtual object to execute an action indicated by the manual control instruction; and
controlling, in response to receiving a voice control instruction, the second virtual object to execute an action indicated by the voice control instruction.
